(19) United States
(12) Patent Application Publication
(10) Pub. No.: US 2016/0191976 A1
(43) Pub. Date: Jun. 30, 2016

(54) TUNER AND METHOD FOR CROSSTALK CANCELLATION

(71) Applicant: AIROHA TECHNOLOGY CORP., HSINCHU (TW)

(72) Inventors: HENG-CHIH LIN, HSINCHU (TW); WEN-SHENG HOU, HSINCHU (TW)

(21) Appl. No.: 14/862,318

(22) Filed: Sep. 23, 2015

(30) Foreign Application Priority Data
Dec. 26, 2014 (TW) 103145646

(51) Int. Cl. H04N 21/426; H04N 21/438; H04N 21/2665

(52) U.S. Cl. CPC H04N 21/4263; H04N 21/2665; H04N 21/4383

(57) ABSTRACT

A tuner for crosstalk cancellation comprises a plurality tuner units and a crosstalk cancellation unit, wherein the crosstalk cancellation unit is connected to each tuner unit. Tuner units are used for receiving analog signals with same frequency band or different frequency bands respectively, and converting the analog signal to a digital signal. The crosstalk cancellation unit receives digital signals from each tuner unit, and executes operation or algorithm of each digital signal to cancel the crosstalk of each analog signal on tuner units and/or analog front ends.

### REFERENCE TO RELATED APPLICATIONS

This application is based on Taiwan application Ser. No. 103145646, filed Dec. 26, 2014, currently pending.

### FIELD OF THE INVENTION

The present invention is related to a tuner and method for crosstalk cancellation for canceling crosstalk of each signal by digital operation.

### BACKGROUND

The transmitting method of the television signal may comprise satellite television, digital television, cable television and terrestrial television. In generally, the frequency band of cable television (CATV) signal may be 330 MHz to 426 MHz. The frequency band of digital television signal, such as DVB-T, may be 450 MHz to 860 MHz. The frequency band of satellite television signal may be 950 MHz to 2150 MHz. For instance, the frequency band of ISDB-S of satellite television signal may be 950 MHz to 1350 MHz, the frequency band of DVB-S/S2 of satellite television may be 1350 MHz to 1600 MHz, and the frequency band of ABS-S of satellite television may be 1600 MHz to 2150 MHz.

Please referring to FIG. 1, a tuner 10 is able to receive television signal from different input ends, and mix and convert television signal. Thus, a television is able to play the operated television signal. For instance, the tuner 10 receives cable television signal from a first input 11, and receives satellite television signal from a second input 13.

As the tuner receives two or more television signals with different frequency bands, crosstalk of each television signal may be occurred, causing noise of each television signal and poor video quality of the television. The isolation of each input end of the turner 10 may be improved to solve above problems. Please referring to FIG. 1, several isolation units 15, such as ground ends, are disposed between the first input end 11 and the second input end 13 to reduce crosstalk of each television signal inputted from the first input end 11 and the second input end 13.

The area of the tuner 10 will be increased with the number of the isolation units 15 and/or the input ends 11/13 thereof. Further, the isolation units 15 are able to isolate television signals within the tuner (chip) 10 to reduce crosstalk of each television signal within the tuner (chip) 10. However, crosstalk of each television signal with different frequency bands may happen on the analog front-end, circuit board or other transmission line outside the tuner (chip) 10. Thus, isolation units should be disposed on the analog front-end, circuit board or other transmission line for isolating television signals to reduce crosstalk of each television signal. Accordingly, the area and production cost of the tuner 10, circuit board and other transmission lines will be increased.

### SUMMARY

It is one object of the present invention to provide a tuner for crosstalk cancellation. The crosstalk cancellation unit is able to execute operation or algorithm of each digital signal to cancel crosstalk of each television signal to improve video quality of the television. Further, it is unnecessary to dispose isolation units within the tuner to isolate each television signal, and thus area and production cost of the tuner will not be increased.

It is one object of the present invention to provide a tuner for crosstalk cancellation. The tuner comprises a plurality of tuner units and a crosstalk cancellation unit, wherein the crosstalk cancellation unit is able to receive signals with same frequency band or different frequency bands by each tuner unit respectively. The crosstalk cancellation unit executes operation or algorithm of each received signal to cancel crosstalk of each signal on each tuner unit or each analog front-end to improve quality of each signal.

It is one object of the present invention to provide a tuner for crosstalk cancellation. The tuner comprises a plurality of tuner units and a crosstalk cancellation unit. Each tuner unit is able to receive analog signals with same frequency band or different frequency bands, and amplify, down convert, filter and/or convert each analog signal respectively to generate a plurality of analog signals. The crosstalk cancellation unit is able to receive each digital signal by each tuner unit respectively, and executes operation or algorithm of each digital signal to cancel crosstalk of each analog signal on each tuner unit or each analog front-end.

For achieving above objects, the present invention provides a tuner for crosstalk cancellation, comprising: a plurality of analog front-ends for receiving or transmitting a plurality of television signals with same frequency band or different frequency bands, wherein each the analog front-end comprises at least one tuner unit, each the television signal is an analog signal, and the tuner unit converts the analog signal to a digital signal; and a crosstalk cancellation unit connected to each analog front-end for receiving the digital signal and executing operation or algorithm of each the digital signal to cancel the crosstalk of each the analog signal of each turner unit or each analog front-end.

Further, the present invention provides a crosstalk cancellation method of a tuner, wherein the tuner comprises a plurality of analog front-ends and a crosstalk cancellation unit, further comprising steps of: receiving or transmitting a plurality of television signals with same frequency band or different frequency bands by the analog front-ends, wherein each the analog front-end comprises at least one tuner unit and each the television signal is an analog signal; converting each the analog signal to a digital signal by the tuner units respectively; receiving each the digital signal form each the tuner unit by the crosstalk cancellation unit; and executing operation or algorithm of each the digital signal by the crosstalk cancellation unit to cancel crosstalk of each the analog signal of each tuner unit or each analog front-end.

In one embodiment of the tuner, each tuner unit is able to amplify, down convert, filter and convert the analog signal.

In one embodiment of the tuner, each tuner unit comprises: a low noise amplifier for amplifying the analog signal; a mixer for down converting the analog signal; a filter for filtering the analog signal; and an analog to digital converter for converting the analog signal to the digital signal.

In one embodiment of the tuner, the low noise amplifier is connected to the crosstalk cancellation unit via the mixer, the filter and the analog to digital converter.

In one embodiment of the tuner, the crosstalk cancellation unit executes the pseudo inverse, the successive interference cancellation, the parallel interference cancellation, the maximum likelihood detection or other digital cancellation of the digital signals.

In one embodiment of the tuner, further comprises a plurality of antennas connected to the each tuner unit respectively for receiving the digital signal with same frequency band or different frequency bands.

In one embodiment of the crosstalk cancellation method, further comprises the step of: amplifying, down converting, filtering and converting each the analog signal by the tuner units.

In one embodiment of the crosstalk cancellation method, further comprises the step of: executing the pseudo inverse, the successive interference cancellation, the parallel interference cancellation, the maximum likelihood detection or other digital cancellation of each the digital signal by the crosstalk cancellation unit.

### BRIEF DESCRIPTION OF THE DRAWINGS

The structure as well as preferred modes of use, further objects, and advantages of this invention will be best understood by referring to the following detailed description of some illustrative embodiments in conjunction with the accompanying drawings, in which:

FIG. 1 is a block diagram of a tuner according to the prior art.

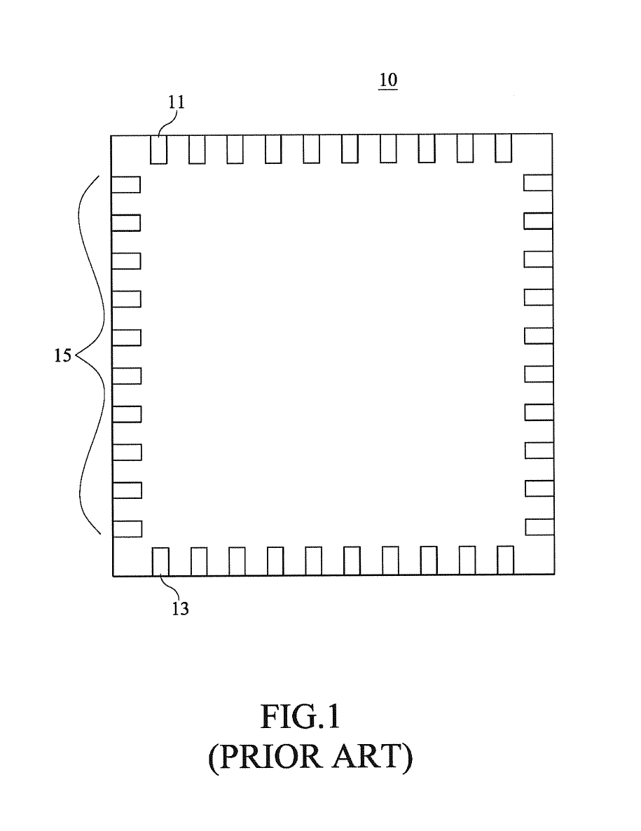

FIG. 2 is a block diagram of a tuner for crosstalk cancellation according to an embodiment of the present invention.

FIG. 3 is a block diagram of a tuner for crosstalk cancellation according to another embodiment of the present invention.

FIG. 4 is a flow chart of a crosstalk cancellation method of a tuner according to an embodiment of the present invention.

### DETAILED DESCRIPTION OF THE PREFERRED EMBODIMENTS

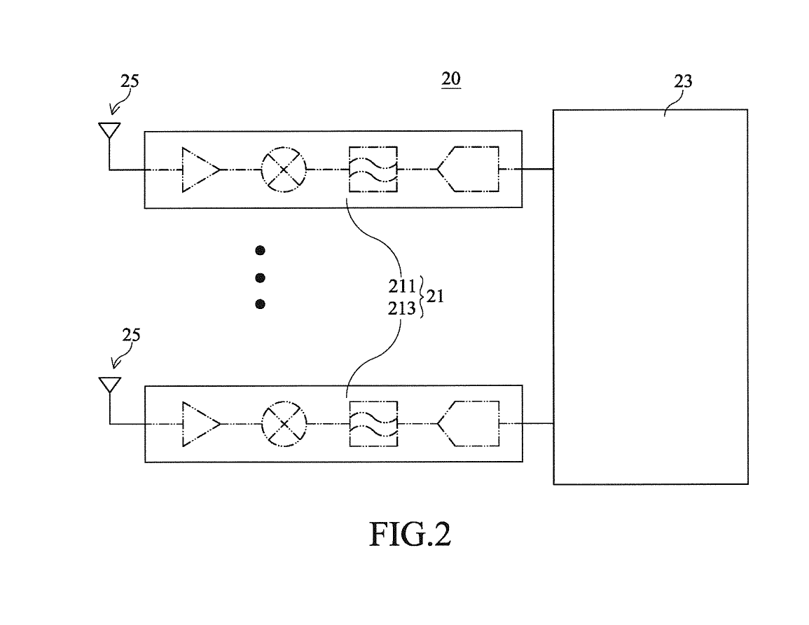

FIG. 2 is a block diagram of a tuner for crosstalk cancellation according to an embodiment of the present invention. The tuner 20 is able to receive several kinds of television signals with same frequency band or different frequency bands. Further, the tuner 20 is able to execute operation or algorithm of the received television signals, and then play the operated television signals on a television.

The tuner 20 comprises a plurality of tuner units 21 and a crosstalk cancellation unit 23, wherein the tuner units 21 are connected to the crosstalk cancellation unit 23. The function of the tuner unit 21 may be similar to the general wireless receiver. For instance, the tuner unit 21 is able to amplify, down convert, filter, convert and/or demodule the received analog signal. Thus, the analog signal is converted to a digital signal, and transmitted to the crosstalk cancellation unit 23. In actual application, the tuner 20 may comprise a plurality of analog front-ends (AFEs) for receiving a plurality of television signals with same frequency band or different frequency bands. The analog front-end may comprise transmission lines, transmission paths or transmission interfaces of the analog signal. For example, the analog front-end comprises air, coaxial cables, RF circuits, the tuner unit 21, transmission lines and so on.

Each tuner unit 21 and each analog front-end of the invention is used to receive television signal with wide frequency band. For instance, each tuner unit 21 is connected to different antennas 25, and receives television signal form different antennas 25 respectively. The antenna 25 is not a necessary device. In other embodiment, the tuner unit 21 may be connected to a transmission line, and receives the television signal via the transmission line.

The structure of the tuner unit 21 may be not same with the general wireless receiver completely. In generally, the turner unit 21 may be single conversion with IF, dual conversion with IF, single conversion with low IF, dual conversion with low IF, dual conversion with zero IF and single conversion with zero IF. The detailed structure of above turner unit 21 is known by any person skilled in the art, and thus it is unnecessary to disclose the detailed structure of each kind of tuner unit 21 in the invention. Further, the structure of above tuner unit 21 is an embodiment of the invention, and is not limitation of the invention. In actual application, the structure of the tuner unit 21 may be different from above description.

In one embodiment of the invention, the tuner units 21 and the analog front-ends of the tuner 20 may be able to receive analog signals or television signals with same frequency band or different frequency bands. For instance, the tuner 21 comprises a first tuner unit 211 for receiving a first analog signal A1, and a second tuner unit 213 for receiving a second analog signal A2, wherein the frequency band of the first analog signal A1 is different from the second analog signal A2. In this embodiment of the invention, the tuner 20 comprises two tuner units 21. However, the number of the tuner units 21 may be more than two.

Crosstalk of each analog signal may occur during transmission process thereof, causing noise of each analog signal transmitted by each tuner unit 21. In one embodiment of the invention, mutual inductance of the first analog signal A1 and the second analog signal A2 may lead to generation of the first interfering signal M1 on the first turner unit 211 and the second interfering signal M2 on the second turner unit 213. The first interfering signal M1 and the second interfering signal M2 are noise for the first analog signal A1 and the second analog signal A2 respectively, causing poor video quality of the television.

The tuner 10 of prior art comprises a plurality of ground ends 15 disposed between each input end 11/13 to isolate each input end (or tuner unit) 11/13 and reduce crosstalk of each analog signal on each input end (or tuner unit) 11/13. However, area of the tuner 10 is increased with the number of the ground ends 15 and/or the input ends 11/13.

It is unnecessary to dispose a plurality of isolation unit between each tuner unit 21 and/or each analog front-end of the tuner 20 of the invention. Thus, area and production cost of the tuner 20 is able to be reduced. The crosstalk cancellation unit 23 receives digital signals from each tuner unit 21, and executes operation or algorithm of each analog signal to cancel crosstalk of each analog signal on each analog front-end and/or tuner unit 21. For instance, the crosstalk cancellation unit 23 is able to cancel the first interfering signal M1 of the first tuner unit 211 and the second interfering signal M2 of the second tuner unit 213 to improve video quality of the television.

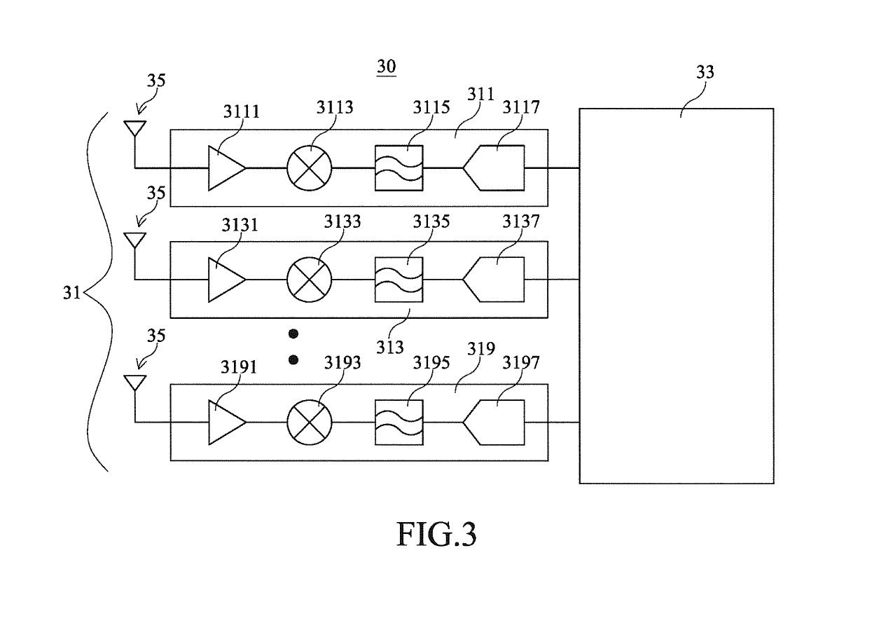

FIG. 3 is a block diagram of a tuner for crosstalk cancellation according to another embodiment of the present invention. The tuner 30 is able to receive several kinds of television signals with different frequency bands. Further, the tuner 30 is able to execute operation or algorithm of the received television signals, and then play the operated television signals on a television.

The tuner 30 comprises a plurality of tuner units 31 and a crosstalk cancellation unit 33, wherein the tuner units 31 are connected to the crosstalk cancellation unit 33. In actual application, the tuner 30 may comprise a plurality of analog front-ends (AFEs) for receiving television signals with same frequency band or different frequency bands. The analog front-ends may be transmission lines, transmission passes or transmission interfaces of the analog signal. For example, the analog front-end comprises air, coaxial cables, RF circuits, the tuner unit 31, transmission lines and so on.

In one embodiment of the invention, each tuner unit 31 may comprise a low noise amplifier (LNA), a mixer, a filter and an analog to digital converter. For instance, the tuner unit 31 comprises a first tuner unit 311, a second tuner unit 313, . . . , and a nth tuner unit 319. Further, the first tuner unit 311 comprises a first low noise amplifier 3111, a first mixer 3113, a first filter 3115, and a first analog to digital converter 3117; the second tuner unit 313 comprises a second low noise amplifier 3131, a second mixer 3133, a second filter 3135, and a second analog to digital converter 3137; . . . ; the nth tuner unit 319 comprises a nth low noise amplifier 3191, a nth mixer 3193, a nth filter 3195, and a nth analog to digital converter 3197.

The low noise amplifier 3111/3131/3191 is able to amplify the anal og signal. The mixer 3113/3133/3193 is able to down convert the analog signal to reduce frequency of the analog signal. For instance, the mixer 3113/3133/3193 is able to module the analog signal with a local oscillator to generate an intermediate frequency. The filter 3115/3135/3195 is able to filter the analog signal. The analog to digital converter 3117/3137/3197 is able to convert the analog signal to a digital signal.

In this embodiment of the invention, the low noise amplifier 3111/3131/3191 is connected to the crosstalk cancellation unit 33 via the mixer 3113/3133/3193, the filter 3115/3135/3195 and the analog to digital convertor 3117/3137/3179 in turn, as shown in FIG. 3. Thus, the tuner unit 31 is able to convert the received analog signal to the digital signal, and transmit the digital signal to the crosstalk cancellation unit 33.

The crosstalk cancellation unit 33 executes operation or algorithm of each digital signal to cancel crosstalk of each analog signal on each analog front-end and/or each tuner unit 31. For instance, the crosstalk cancellation unit 33 is able to execute the pseudo inverse, the successive interference cancellation, the parallel interference cancellation, the maximum likelihood detection or other digital cancellation of digital signals to cancel crosstalk of analog signals on the analog front-ends and/or the tuner units 31. Further, above algorithm method for cancelling crosstalk is an embodiment of the invention, and is not limitation of the invention.

In one embodiment of the invention, the first tuner unit 311 is able to receive a first analog signal A1, the second tuner unit 313 is able to receive a second analog signal A2, . . . , and the nth tuner unit 319 is able to receive a nth analog signal An, wherein the frequency bands of the first analog signal A1, the second analog signal A2, . . . , and the nth analog signal An may be difference. Mutual inductance of the first analog signal A1, the second analog signal A2, . . . , and the nth analog signal An may lead to generation of a first interfering signal M1 on the first turner unit 311, a second interfering signal M2 on the second tuner unit 313, . . . , and a nth interfering signal Mn on the nth turner unit 319. The first interfering signal M1, the second interfering signal M2, . . . , and the nth interfering signal Mn are noise for the first analog signal A1, the second analog signal A2, . . . , and the nth analog signal An respectively, causing poor video quality of the television. The crosstalk cancellation unit 33 executes operation or algorithm of first analog signal A1, the first interfering signal M1, the second analog signal A2, the second interfering signal M2, . . . , the nth analog signal An, and the nth interfering signal Mn to cancel the first interfering signal M1 of the first turner unit 311, the second interfering signal M2 of the second tuner unit 313, . . . , and the nth interfering signal Mn of the nth tuner unit 319.

FIG. 3 discloses the low noise amplifier 3111/3131/3191 is connected to the crosstalk cancellation unit 33 via the mixer 3113/3133/3193, the filter 3115/3135/3195 and the analog to digital convertor 3117/3137/3179 in turn. However, the sequence of those devices is not limitation of the invention. In actual application, the sequence of the low noise amplifier 3111/3131/3191, the mixer 3113/3133/3193, the filter 3115/3135/3195 and the analog to digital convertor 3117/3137/3179 may be changed, and the tuner units 31 are able to amplify, down convert, filter, and convert the analog signal.

The tuner 30 of FIG. 3 is an embodiment of the invention, and is not limitation of the invention. In actual application, the tuner 30 may be single conversion with IF, dual conversion with IF, single conversion with low IF, dual conversion with low IF, dual conversion with zero IF, single conversion with zero IF and so on.

In one embodiment of the invention, each tuner unit 31 is connected to different antenna 35, and receives television signal with same frequency band or different frequency bands by the connected antenna 35. However, the antenna 35 is not a necessary device. In other embodiment, the tuner unit 31 may be connected to a transmission line, and receives television signal via the transmission line.

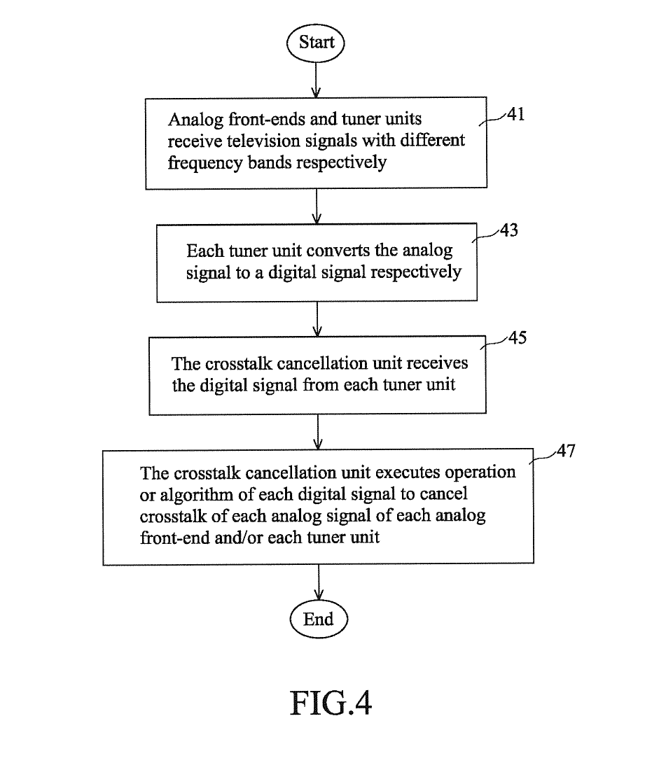

FIG. 4 is a flow chart of a crosstalk cancellation method of a tuner according to an embodiment of the present invention. As illustrated and please referring to FIG. 2 and FIG. 3, the tuner 20/30 is able to receive several kinds of television signals, wherein the tuner 20/30 comprises a plurality of tuner units 21/31 and a crosstalk cancellation unit 23/33. Further, the tuner 20/30 may comprise a plurality of analog front-ends (AFEs), wherein the analog front-end comprises the tuner unit 21/31.

Each analog front-end and tuner unit 21/31 of the tuner 20/30 is able to receive television signals with same frequency band or different frequency bands, wherein the television signal is an analog signal, as the step 41. Each tuner unit 21/31 converts the analog signal to a digital signal, as the step 43. In other embodiment, the tuner 21/31 is able to amplify, down convert, filter, and convert the analog signal.

The crosstalk cancellation unit 23/33 receives the digital signal from each tuner unit 21/31, as the step 45. Then, the crosstalk cancellation unit 23/33 executes operation or algorithm of each digital signal to cancel crosstalk of each analog signal of each analog front-end and/or each tuner unit 21. For instance, the crosstalk cancellation unit 23/33 is able to execute the pseudo inverse, the successive interference cancellation, the parallel interference cancellation, the maximum likelihood detection or other digital cancellation of each digital signal to cancel crosstalk of each analog signal of each analog front-end and/or each tuner unit 21/31, as step 47.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

What is claimed is:

1. A tuner for crosstalk cancellation, comprising:
a plurality of analog front-ends for receiving or transmitting a plurality of television signals with same frequency band or different frequency bands, wherein each said analog front-end comprises at least one tuner unit, each said television signal is an analog signal, and said tuner unit converts said analog signal to a digital signal; and
a crosstalk cancellation unit connected to each analog front-end for receiving said digital signal and executing operation or algorithm of each said digital signal to cancel the crosstalk of each said analog signal of each turner unit or each analog front-end.

2. The tuner according to claim 1, wherein said each tuner unit is able to amplify, down convert, filter and convert said analog signal.

3. The tuner according to claim 1, wherein each said tuner unit comprises:
a low noise amplifier for amplifying said analog signal;
a mixer for down converting said analog signal;
a filter for filtering said analog signal; and
an analog to digital converter for converting said analog signal to said digital signal.

4. The tuner according to claim 3, wherein said low noise amplifier is connected to said crosstalk cancellation unit via said mixer, said filter and said analog to digital converter.

5. The tuner according to claim 1, wherein said crosstalk cancellation unit executes the pseudo inverse, the successive interference cancellation, the parallel interference cancellation, the maximum likelihood detection or other digital cancellation of said digital signals.

6. The tuner according to claim 1, further comprising a plurality of antennas connected to said each tuner unit respectively for receiving said digital signal with same frequency band or different frequency bands.

7. A crosstalk cancellation method of a tuner, wherein said tuner comprises a plurality of analog front-ends and a crosstalk cancellation unit, further comprising steps of:
receiving or transmitting a plurality of television signals with same frequency band or different frequency bands by said analog front-ends, wherein each said analog front-end comprises at least one tuner unit and each said television signal is an analog signal;
converting each said analog signal to a digital signal by said tuner units respectively;
receiving each said digital signal form each said tuner unit by said crosstalk cancellation unit; and
executing operation or algorithm of each said digital signal by said crosstalk cancellation unit to cancel crosstalk of each said analog signal of each tuner unit or each analog front-end.

8. The crosstalk cancellation method according to claim 7, further comprising the step of:
amplifying, down converting, filtering and converting each said analog signal by said tuner units.

9. The crosstalk cancellation method according to claim 7, further comprising the step of:
executing the pseudo inverse, the successive interference cancellation, the parallel interference cancellation, the maximum likelihood detection or other digital cancellation of each said digital signal by said crosstalk cancellation unit.
